(19) United States
(12) Patent Application Publication
(10) Pub. No.: US 2018/0308615 A1
(43) Pub. Date: Oct. 25, 2018

(54) MAGNETIC ASSEMBLY, INDUCTOR AND TRANSFORMER

(71) Applicant: DELTA ELECTRONICS, INC., Toayuan City (TW)

(72) Inventors: Hsin-Wei Tsai, Taoyuan City (TW); Hua-Sheng Lin, Taoyuan City (TW)

(21) Appl. No.: 15/632,054

(22) Filed: Jun. 23, 2017

(30) Foreign Application Priority Data
Apr. 25, 2017 (CN) 201710277171.2

(51) Int. Cl. H01F 27/24; H01F 27/28

(52) U.S. Cl. CPC H01F 27/24; H01F 3/14; H01F 27/28

(57) ABSTRACT

A magnetic assembly includes a magnetic core set including a first and a second magnetic cores. The first magnetic core and the second magnetic core, which are disposed opposite to each other, each includes a main body, a central projection, a first projection and a second projection. The main body has a central portion, a first portion and a second portion. The central portion is located between the first portion and the second portion. The central projection is extended from the central portion. The first projection is extended from the first portion. The second projection is extended from the second portion. The lengths of the first projection and the second projection are equal, and the length of the central projection is greater than the length of the first projection. Therefore, the volume of product is reduced and the difficulty of process is lowered.

### CROSS-REFERENCE TO RELATED APPLICATION

This application claims priority from China Patent Application No. 201710277171.2, filed on Apr. 25, 2017, the entire contents of which are incorporated herein by reference for all purposes.

### TECHNICAL FIELD

The present disclosure relates to a magnetic assembly, and more particularly to a magnetic assembly constructed by at least one inductor and/or at least one transformer.

### BACKGROUND

Magnetic assemblies such as transformers and inductors, are the most popular components in the electronic field. Recently, driven by the trend of thinning the product and keeping quality, it is positively developed to increase the performance of the magnetic assemblies in the industrial.

In general, a conventional transformer can be taken as an example of the common magnetic assembly. Please refer to FIG. 1 to FIG. 4. FIG. 1 schematically illustrates the partial structure of a conventional transformer of prior art. FIG. 2 schematically illustrates a conventional transformer disposed on a circuit board. FIG. 3 schematically illustrates the combined view of a single magnetic core set and the winding thereof of a conventional transformer. FIG. 4 schematically illustrates the exploded view of a single magnetic core set and the winding thereof of a conventional transformer. A conventional transformer is composed of two magnetic core sets 11 (one magnetic core of the second magnetic core set 11 is omitted to emphasize the inner coil structure). Since it is necessary to be composed of two magnetic core sets 11, it must be fixed through a specific fixture in the manufacturing process, which is inconvenient. Moreover, the inductance values of the two magnetic core sets 11 have to be respectively controlled, and the inductance difference between the two magnetic core sets 11 cannot exceed 30 μH, otherwise the imbalance phenomena of circuit and magnetic circuit will occur, thereby causing the negative side voltages of transformer induction being different, the rectifier circuit not working in the each half conditions. The efficiency is relatively worse, the temperatures of components are relatively higher, and the inductance value is not easy to be controlled.

Meanwhile, because of the structural features of the magnetic core set 11 of the conventional transformer 1, the wires 12 of the magnetic core set 11 have to be welded and additionally covered by a sleeve 13 so as to be insulated and connected. Also, as shown in FIG. 2, since two sides are closed by the lateral post 111, a circuit board can be merely disposed on the rest two sides of the conventional transformer 1, and only the rest two sides can be utilized for heat-dissipation when the conventional transformer 1 has to be disposed on the circuit board 2.

Furthermore, since the cores of the conventional transformer 1 will be mutually interfered when the cores are too close, the output voltage ripple sizes are different. Because the conventional transformer 1 cannot be made to have the cores 100% identical, so the induced voltages are also different, such that the spike on the rectifier component becomes larger, which has to be solved by increasing the proportion of clamp, however the efficiency will be decreased.

Therefore, there is a need of providing an improved magnetic assembly, an improved inductor and an improved transformer distinct from the prior art in order to solve the above drawbacks.

### SUMMARY

Some embodiments of the present disclosure are to provide a magnetic assembly, an inductor and a transformer in order to overcome at least one of the above-mentioned drawbacks encountered by the prior arts.

The present disclosure provides a magnetic assembly, an inductor and a transformer. By the structural features of the length relation between the central projections and the first and second projections of the first magnetic core and the second magnetic core of the magnetic core set, the heat-dissipating directions and the disposed directions between the magnetic assembly and the circuit board of the present disclosure are at least one more direction than the prior art. Meanwhile, no fixture is needed to fix the magnetic core set in the magnetic assembly of the present disclosure. Only the central projection has to be grinded to control the inductance through the air gap due to the single inductance. No imbalance phenomena will be occurred. Therefore, not only the technical issues can be effectively solved without welding and utilizing sleeves, but also the product is thinned, the difficulty of process is lowered, and the magnetic assembly is flexibly applied.

The present disclosure also provides a magnetic assembly, an inductor and a transformer. By respectively disposing the first coil, the second coil, the third coil and the fourth coil on the first projections and the second projections of the first magnetic core and the second magnetic core, the coil(s) can be wound by single wire. Furthermore, windings and copper plates can be chosen for meeting demands with the changes of connections in series and connections in parallel, so that the combination of a transformer and an inductor, a transformer with primary side connected in series and secondary side connected in parallel, two independent transformers, and two independent inductor can be implemented. The design is full of diversity. Simultaneously, since the directions of the magnetic fields of the first projection and the second projection are opposite, the magnetic flux can be neutralized and balanced at the central projection, thereby lowering the sudden wave of the rectifier component and then enhancing the efficiency.

In accordance with an aspect of the present disclosure, there is provided a magnetic assembly. The magnetic assembly includes a magnetic core set. The magnetic core set includes a first magnetic core and a second magnetic core. The first magnetic core and the second magnetic core are disposed opposite to each other. The first magnetic core and the second magnetic core each includes a main body, a central projection, a first projection and a second projection. The main body has a central portion, a first portion and a second portion. The central portion is located between the first portion and the second portion. The central projection is extended from the central portion. The first projection is extended from the first portion. The second projection is extended from the second portion. The length of the first projection and the length of the second projection are equal, and the length of the central projection is greater than the length of the first projection.

In some embodiments, the main body has a first width edge and a second width edge disposed opposite to each other, and a first length edge and a second length edge disposed opposite to each other. The central projection is extended from the central portion along the first width edge to the second width edge, and the width of the central projection corresponded to the first width edge and the width of the central projection corresponded to the second width edge are greater than the width of the central projection corresponded to a center of the main body, so that the central projection is partially shrinkage-shaped.

Furthermore, the first projection is cylindrical and adjacent to the first length edge, and the second projection is cylindrical and adjacent to the second length edge.

In some embodiments, the cross-sectional area of the central projection is 1.5-2.5 multiple of the cross-sectional area of the first projection.

Preferably, the cross-sectional area of the central projection is twice of the cross-sectional area of the first projection, and the cross-sectional area of the first projection is equal to the cross-sectional area of the second projection.

In some embodiments, the central projection is made of first material, the first projection and the second projection are made of second material, and the magnetic permeability of the first material is similar or equal to the magnetic permeability of the second material.

In some embodiments, the central projection is made of first material, the first projection and the second projection are made of second material, and the magnetic permeability of the first material is greater than the magnetic permeability of the second material.

In some embodiments, the central projection is made of first material, the first projection and the second projection are made of second material, and the magnetic permeability of the first material is less than the magnetic permeability of the second material.

In some embodiments, the magnetic assembly further includes a first coil, a second coil, a third coil and a fourth coil. The first coil, the second coil, the third coil and the fourth coil are respectively disposed on the first projection of the first magnetic core, the second projection of the first magnetic core, the first projection of the second magnetic core and the second projection of the second magnetic core.

Furthermore, the first coil is a primary coil, and the third coil is a secondary coil.

In an embodiment, the second coil and the fourth coil are windings.

In an embodiment, the second coil is a winding connected with the first coil in series, and the fourth coil is a copper plate connected with the third coil in parallel.

In an embodiment, the first coil and the second coil are wound by single one wire.

In another embodiment, the second coil is another primary coil, and the fourth coil is another secondary coil.

In some embodiments, the first coil, the second coil, the third coil and the fourth coil are windings.

In some embodiments, the height of the first projection of the first magnetic core is equal to the height of the second projection of the first magnetic core, and the height of the first projection of the first magnetic core is greater than the height of the central projection of the first magnetic core.

In some embodiments, the height of the first projection of the second magnetic core is equal to the height of the second projection of the second magnetic core, and the height of the first projection of the second magnetic core is greater than the height of the central projection of the second magnetic core.

In accordance with another aspect of the present disclosure, there is provided an inductor. The inductor includes a magnetic core set, a first coil, a second coil, a third coil and a fourth coil. The magnetic core set includes a first magnetic core and a second magnetic core. The first magnetic core and the second magnetic core are disposed opposite to each other. The first magnetic core and the second magnetic core each includes a main body, a central projection, a first projection and a second projection. The main body has a central portion, a first portion and a second portion. The central portion is located between the first portion and the second portion. The central projection is extended from the central portion. The first projection is extended from the first portion. The second projection is extended from the second portion. The length of the first projection and the length of the second projection are equal, and the length of the central projection is greater than the length of the first projection. The first coil is disposed on the first projection of the first magnetic core. The second coil is disposed on the second projection of the first magnetic core. The third coil is disposed on the first projection of the second magnetic core and connected with the first coil. The fourth coil is disposed on the second projection of the second magnetic core and connected with the second coil. The first coil, the second coil, the third coil and the fourth coil are windings.

In accordance with another aspect of the present disclosure, there is provided a transformer. The transformer includes a magnetic core set, a first coil, a second coil, a third coil and a fourth coil. The magnetic core set includes a first magnetic core and a second magnetic core. The first magnetic core and the second magnetic core are disposed opposite to each other. The first magnetic core and the second magnetic core each includes a main body, a central projection, a first projection and a second projection. The main body has a central portion, a first portion and a second portion. The central portion is located between the first portion and the second portion. The central projection is extended from the central portion. The first projection is extended from the first portion. The second projection is extended from the second portion. The length of the first projection and the length of the second projection are equal, and the length of the central projection is greater than the length of the first projection. The first coil is disposed on the first projection of the first magnetic core. The second coil is disposed on the second projection of the first magnetic core and connected with the first coil in series. The third coil is disposed on the first projection of the second magnetic core. The fourth coil is disposed on the second projection of the second magnetic core and connected with the third coil in parallel. The first coil and the second coil are primary coils, and the third coil and the fourth coil are secondary coils.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 schematically illustrates the partial structure of a conventional transformer of prior art;

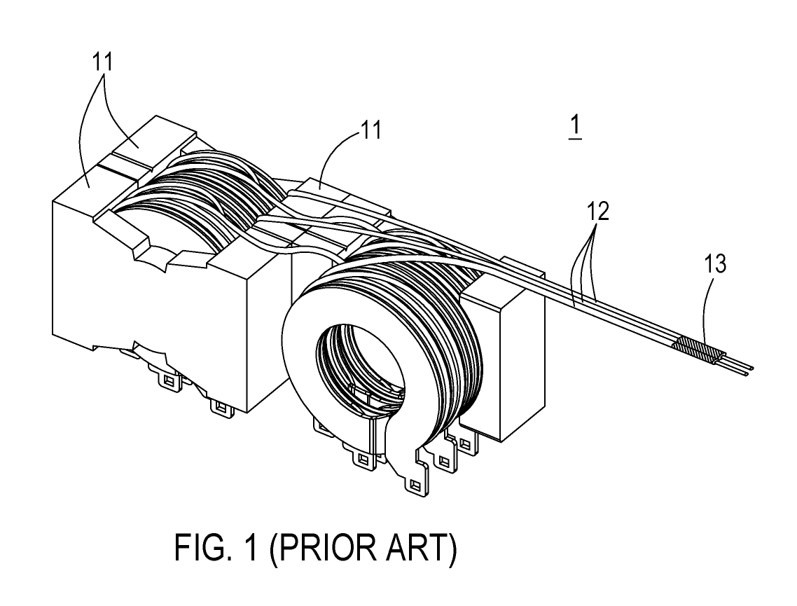

FIG. 2 schematically illustrates a conventional transformer disposed on a circuit board;

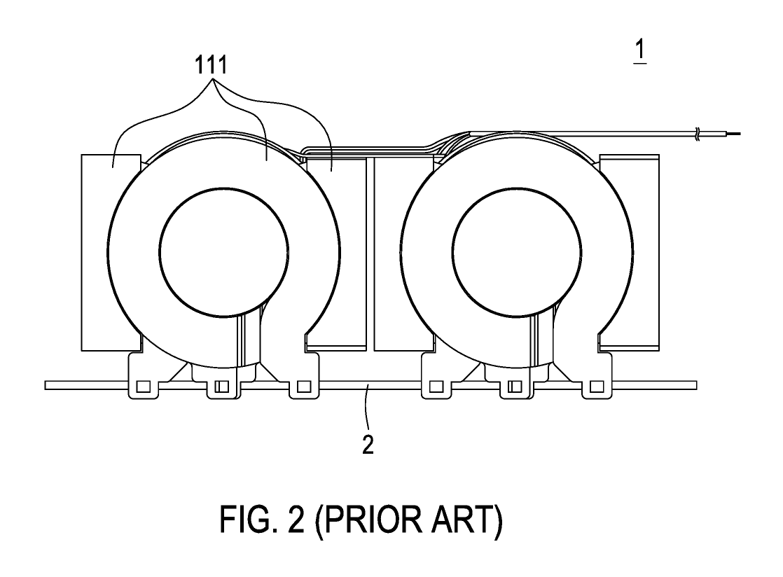

FIG. 3 schematically illustrates the combined view of a single magnetic core set and the winding thereof of a conventional transformer;

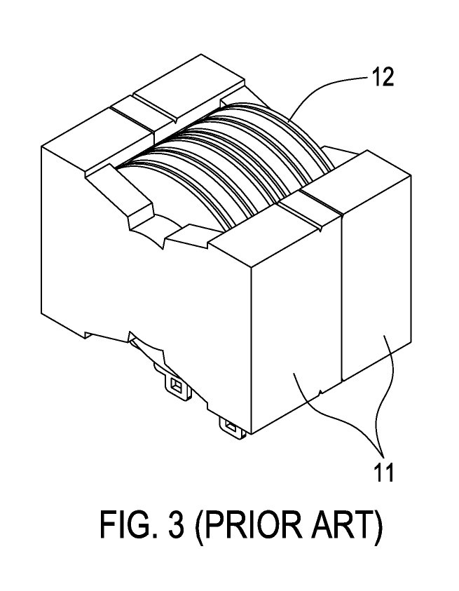

FIG. 4 schematically illustrates the exploded view of a single magnetic core set and the winding thereof of a conventional transformer;

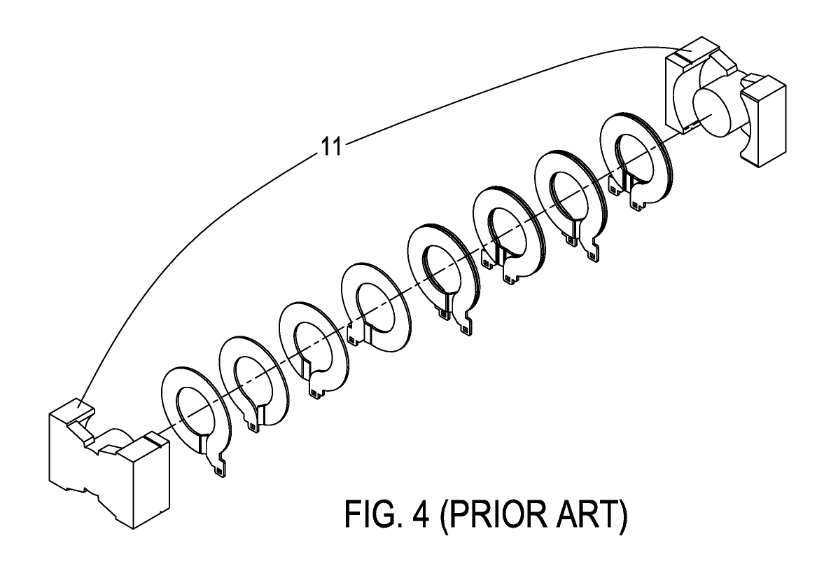

FIG. 5 schematically illustrates the exploded view of a magnetic assembly according to an embodiment of the present disclosure;

FIG. 6 schematically illustrates the top view of a first magnetic core of a magnetic core set of a magnetic assembly according to an embodiment of the present disclosure;

FIG. 7 schematically illustrates the structure of a first magnetic core of a magnetic core set of a magnetic assembly according to an embodiment of the present disclosure;

FIG. 8 schematically illustrates the heat-dissipating directions of a first magnetic core according to an embodiment of the present disclosure;

FIG. 9 schematically illustrates the configuration between a first magnetic core and a circuit board according to an embodiment;

FIG. 10 schematically illustrates the structure of a magnetic assembly according to an embodiment of the present disclosure;

FIG. 11 schematically illustrates the structure of another magnetic assembly according to an embodiment of the present disclosure;

FIG. 12 schematically illustrates the first coil and the second coil shown in FIG. 11 wound by a single wire;

FIG. 13 schematically illustrates the structure of another magnetic assembly according to an embodiment of the present disclosure; and

FIG. 14 schematically illustrates the structure of another magnetic assembly according to an embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

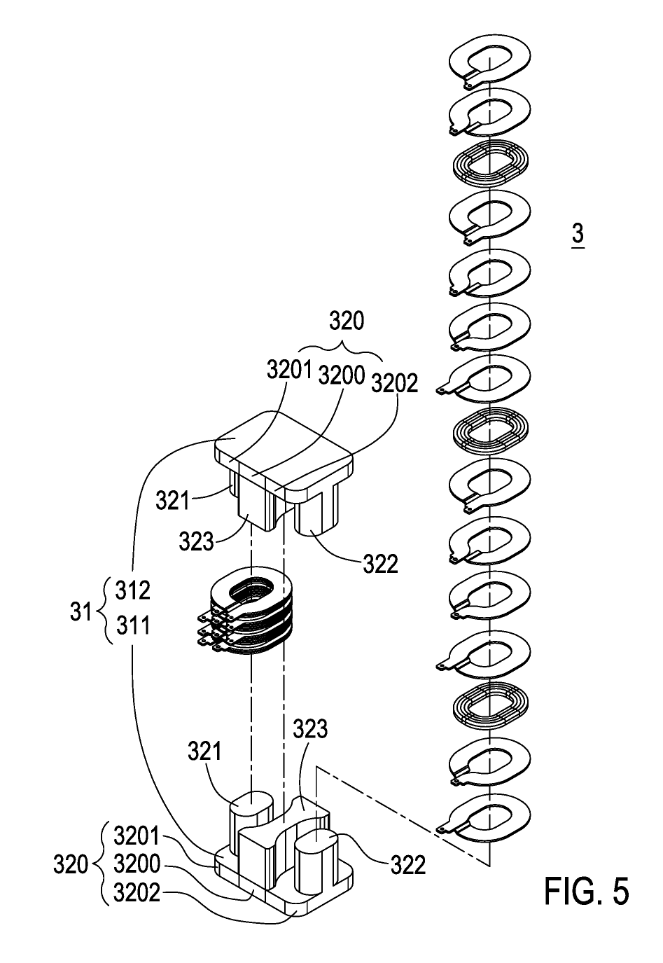

Please refer to FIG. 5. FIG. 5 schematically illustrates the exploded view of a magnetic assembly according to an embodiment of the present disclosure. As shown in FIG. 5, a magnetic assembly 3 according to an embodiment of the present disclosure includes a magnetic core set 31. The magnetic core set 31 includes a first magnetic core 311 and a second magnetic core 312. The first magnetic core 311 and the second magnetic core 312 are disposed opposite to each other. The first magnetic core 311 and the second magnetic core 312 each includes a main body 320, a first projection 321, a second projection 322 and a central projection 323. In this embodiment, for example, the first projection 321, the second projection 322 and the central projection 323 are posts, but not limited herein. The main body 320 has a central portion 3200, a first portion 3201 and a second portion 3202. The central portion 3200 is located between the first portion 3201 and the second portion 3202. The central projection 323 is extended from the central portion 3200. The first projection 321 is extended from the first portion 3201. The second projection 322 is extended from the second portion 3202. The length of the first projection 321 and the length of the second projection 322 are equal, and the length of the central projection 323 is greater than the length of the first projection 321 (also the length of the second projection 322).

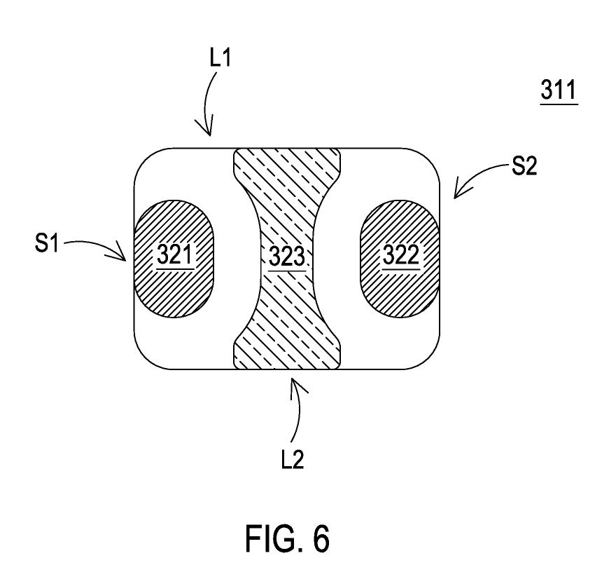

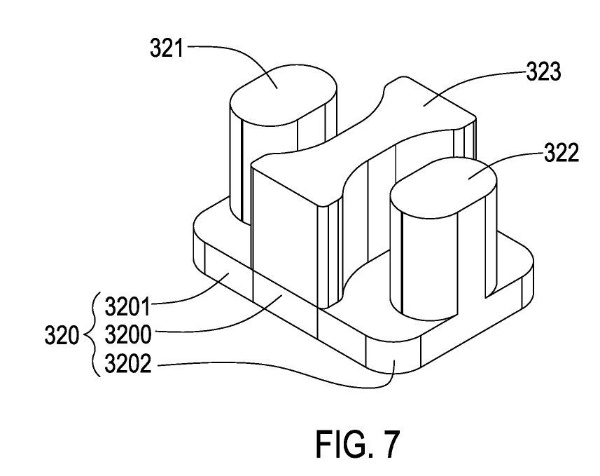

Please refer to FIG. 5, FIG. 6 and FIG. 7. FIG. 6 schematically illustrates the top view of a first magnetic core of a magnetic core set of a magnetic assembly according to an embodiment of the present disclosure. FIG. 7 schematically illustrates the structure of a first magnetic core of a magnetic core set of a magnetic assembly according to an embodiment of the present disclosure. As shown in FIGS. 5-7, the first magnetic core 311 of the magnetic core set 31 is taken for example as following. It should be noted that the second magnetic core 312 has the similar structural features as the first magnetic core 311, so that it is not redundantly described herein. In some embodiments, the main body 320 has a first width edge L1 and a second width edge L2 disposed opposite to each other, and a first length edge S1 and a second length edge S2 disposed opposite to each other. The central projection 323 is extended from the central portion 3200 along the first width edge L1 to the second width edge L2. The width of the central projection 323 corresponded to the first width edge L1 and the width of the central projection 323 corresponded to the second width edge L2 are each greater than the width of the central projection 323 corresponded to a center of the main body 320, so that the central projection 323 is partially shrinkage-shaped (i.e. formed as a partial shrinkage shape). Furthermore, the first projection 321 is cylindrical and adjacent to the first length edge S1, and in this embodiment, a cross section of the first projection 321 is oval or formed as a field shape, and the second projection 322 is cylindrical and adjacent to the second length edge S2, and in this embodiment, a cross section of the second projection 322 is oval or formed as a field shape, but not limited herein.

In some embodiments, the cross-sectional area of the central projection 323 is 1.5-2.5 multiple of the cross-sectional area of the first projection 321 (also can be 1.5-2.5 multiple of the cross-sectional area of the second projection 322). Preferably, the cross-sectional area of the central projection 323 is twice of the cross-sectional area of the first projection 321, and the cross-sectional area of the first projection 321 is equal to the cross-sectional area of the second projection 322. In particular, when the cross-sectional area of the central projection 323 is greater than twice of the cross-sectional area of the first projection 321, the performance is similar with the situation that the cross-sectional area of the central projection 323 is twice of the cross-sectional area of the first projection 321, however more volume is occupied; when the cross-sectional area of the central projection 323 is less than twice of the cross-sectional area of the first projection 321, the total performance of the magnetic assembly 3 is worse. That is, it is preferred that the cross-sectional area of the central projection 323 is twice of the cross-sectional area of the first projection 321.

In some embodiments, the central projection 323 of the first magnetic core 311 or the second magnetic core 312 is made of first material. The first projection 321 and the second projection 322 of the first magnetic core 311 or the second magnetic core 312 are made of second material. The magnetic permeability of the first material is similar or equal to the magnetic permeability of the second material.

In some embodiments, the central projection 323 of the first magnetic core 311 or the second magnetic core 312 is made of first material. The first projection 321 and the second projection 322 of the first magnetic core 311 or the second magnetic core 312 are made of second material. The magnetic permeability of the first material is greater than the magnetic permeability of the second material.

In some embodiments, the central projection 323 of the first magnetic core 311 or the second magnetic core 312 is made of first material. The first projection 321 and the second projection 322 of the first magnetic core 311 or the second magnetic core 312 are made of second material. The magnetic permeability of the first material is less than the magnetic permeability of the second material.

In some embodiments, the heights of the first projection 321, the second projection 322 and the central projection 323 of the first magnetic core 311 and the heights of the first projection 321, the second projection 322 and the central projection 323 of the second magnetic core 312 are preferred to be equal. In another embodiments, the central projection 323 of the first magnetic core 311 and the central projection 323 of the second magnetic core 312 can be singularly grinded or both grinded for meeting the practical demands, so that an air gap is formed, and then the inductance can be controlled since the air gap can be changed. In other words, after the central projection 323 of the first magnetic core 311 is grinded, the height of the first projection 321 of the first magnetic core 311 is equal to the height of the second projection 322 of the first magnetic core 311, and the height of the first projection 321 of the first magnetic core 311 is greater than the height of the central projection 323 of the first magnetic core 311. On the other hand, after the central projection 323 of the second magnetic core 312 is grinded, the height of the first projection 321 of the second magnetic core 312 is equal to the height of the second projection 322 of the second magnetic core 312, and the height of the first projection 321 of the second magnetic core 312 is greater than the height of the central projection 323 of the second magnetic core 312.

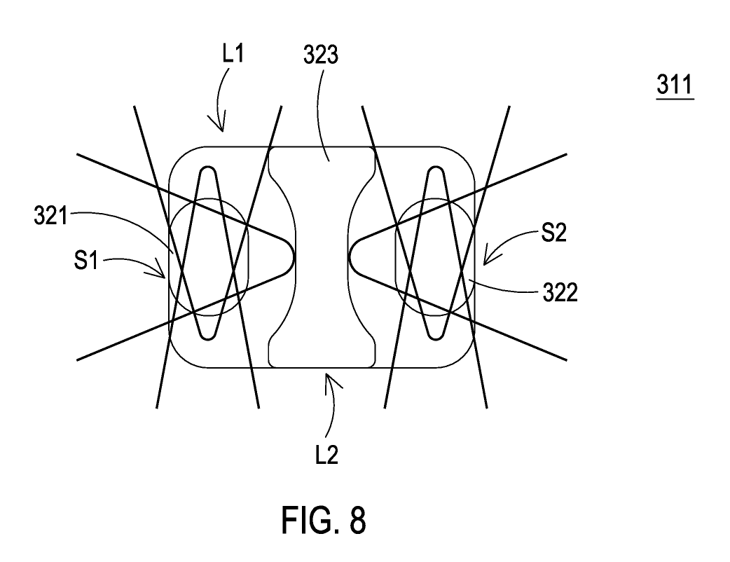

Please refer to FIG. 5 and FIG. 8. FIG. 8 schematically illustrates the heat-dissipating directions of a first magnetic core according to an embodiment of the present disclosure. The heat-dissipation directions of the first magnetic core 311 shown in FIG. 8 are at least the top of the first projection 321 corresponded to the first width edge L1, the bottom of the first projection 321 corresponded to the second width edge L2 and the left of the first projection 321 corresponded to the first length edge S1, and the top of the second projection 322 corresponded to the first width edge L1, the bottom of the second projection 322 corresponded to the second width edge L2 and the right of the second projection 322 corresponded to the second length edge S2 (i.e. the directions of the opening of the curves shown in FIG. 8). In prior art, only the top and the bottom of a central projection can be utilized for heat-dissipation. That is, compared with prior art, the magnetic assembly of the present disclosure apparently has more and better heat-dissipating directions, such that the heat-dissipation efficiency must be enhanced.

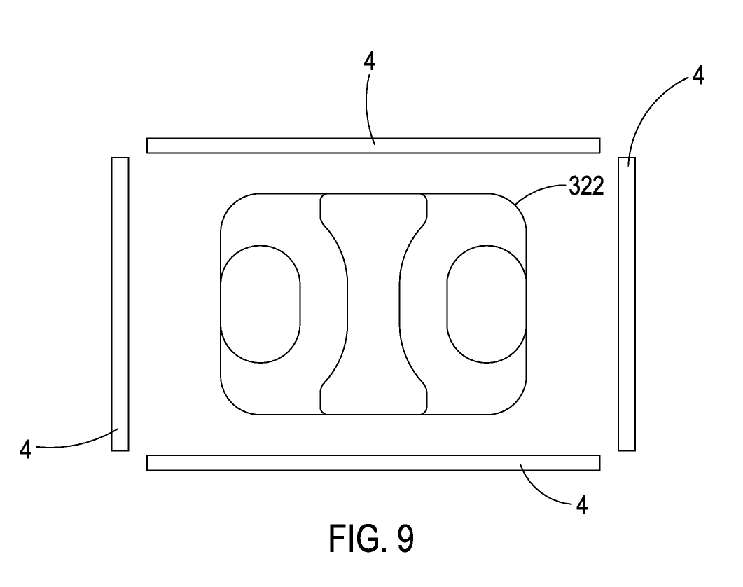

Please refer to FIG. 5 and FIG. 9. FIG. 9 schematically illustrates the configuration between a first magnetic core and a circuit board according to an embodiment. As shown in FIG. 5 and FIG. 9, since none of a closed structure is disposed on the sides of the first magnetic core 311, a circuit board 4 can be disposed on any direction of the four directions that surround the first magnetic core 311 to meet the requirements. Particularly, the circuit board 4 can be disposed on the top of the first magnetic core 311, the bottom of the first magnetic core 311, the left of the first magnetic core 311, or the right of the first magnetic core 311.

In brief, by the structural features of the length relation between the central projections and the first and second projections of the first magnetic core and the second magnetic core of the magnetic core set, the heat-dissipating directions and the disposed directions between the magnetic assembly and the circuit board of the present disclosure are at least one more direction than the prior art. Meanwhile, no fixture is needed to fix the magnetic core set in the magnetic assembly of the present disclosure. Only the central projection has to be grinded to control the inductance through the air gap due to the single inductance. No imbalance phenomena will be occurred. Therefore, not only the technical issues can be effectively solved without welding and utilizing sleeves, but also the product is thinned, the difficulty of process is lowered, and the magnetic assembly can be flexibly applied.

In some embodiments, for meeting the demands, the magnetic assembly of the present disclosure can utilize different coils, such as windings or copper plates, to implement a combination of a transformer and an inductor, a transformer which can be considered as a combination of two transformers with primary side connected in series and secondary side connected in parallel, two independent transformers, or two independent inductors. In other words, only one magnetic core set (i.e. a pair of magnetic cores) is needed for setting a combination of any two of transformer(s) and/or inductor(s). In comparison, two magnetic core sets are needed in prior art. For example, one pair of magnetic cores are configured as a transformer and another pair of magnetic cores are configured as an inductor. Since each magnetic core has tolerances and errors, it is difficult and complex to adjust the factors and parameters of two pairs of magnetic cores and hard to control the features while pairing or matching. On the contrast, only one pair of magnetic core is needed in the present disclosure, so the parameters are easy to be adjusted, and the product features are easy to be controlled.

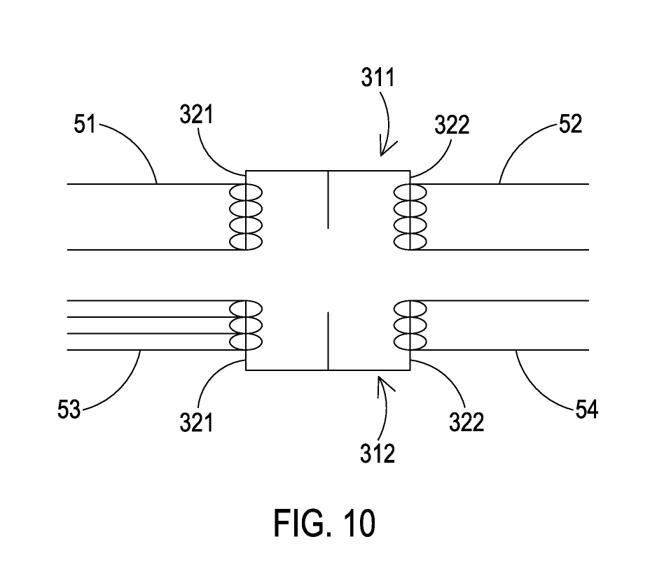

Please refer to FIG. 5 and FIG. 10. FIG. 10 schematically illustrates the structure of a magnetic assembly according to an embodiment of the present disclosure. As shown in FIG. 5 and FIG. 10, in some embodiments, the magnetic assembly of the present disclosure further includes a first coil 51, a second coil 52, a third coil 53 and a fourth coil 54. The first coil 51, the second coil 52, the third coil 53 and the fourth coil 54 are respectively disposed on the first projection 321 of the first magnetic core 311, the second projection 322 of the first magnetic core 311, the first projection 321 of the second magnetic core 312 and the second projection 322 of the second magnetic core 312. Furthermore, to configure the combination of a transformer and an inductor as shown in FIG. 10, the first coil 51 is preferred to be a primary coil (e.g. a primary winding), and the third coil 53 is preferred to be a secondary coil (e.g. a secondary copper plate), but not limited thereto. The second coil 52 and the fourth coil 54 are windings. In brief, as shown in FIG. 10, the left side of the first magnetic core 311 and the second magnetic core 312 is structured as a transformer, and the right side of the first magnetic core 311 and the second magnetic core 312 is structured as an inductor. The transformer and the inductor are integrated as one magnetic assembly. The space utility is significantly enhanced, and the heat-dissipating efficiency is better than one in prior art, which is described in the above-mentioned embodiments.

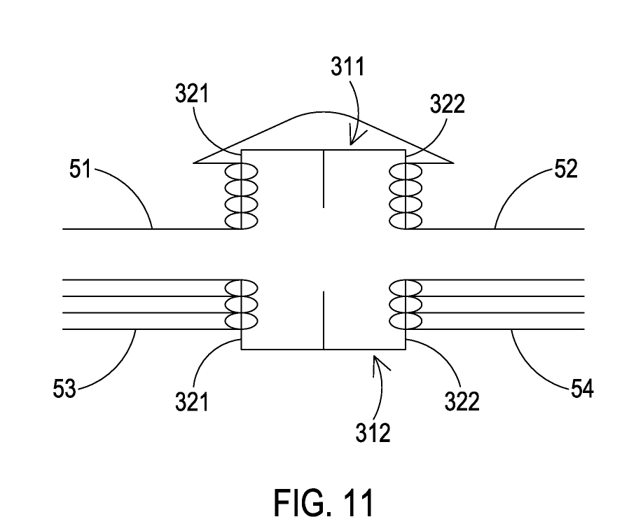

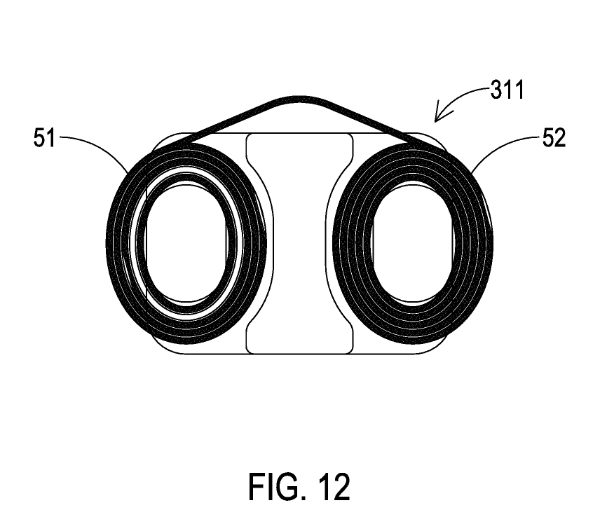

Please refer to FIG. 11 and FIG. 12. FIG. 11 schematically illustrates the structure of another magnetic assembly according to an embodiment of the present disclosure. FIG. 12 schematically illustrates the first coil and the second coil shown in FIG. 11 wound by a single wire. As shown in FIG. 11 and FIG. 12, the first coil 51, the second coil 52, the third coil 53 and the fourth coil 54 are respectively disposed on the first projection 321 of the first magnetic core 311, the second projection 322 of the first magnetic core 311, the first projection 321 of the second magnetic core 312 and the second projection 322 of the second magnetic core 312. The first coil 51 is a primary coil, the third coil 53 is a secondary coil, the second coil 52 is a primary coil (preferably a primary winding) connected with the first coil 51 in series, in which the first coil 51 and the second coil 52 can be wound by single one wire, and the fourth coil 54 is a cooper plate connected with the third coil 53 in parallel. As a result, the magnetic assembly 3 of the present disclosure is structured as two transformers with primary side connected in series and secondary side connected in parallel. It should be noted that two pairs of magnetic cores are necessary to implement these transformers in the manner of prior art. The occupied volume of prior art is much greater than the one of the present disclosure. In prior art, the feature differences are hard to be controlled while matching the magnetic cores. That is, the magnetic assembly of the present disclosure apparently has efficacy that cannot be achieved by prior art.

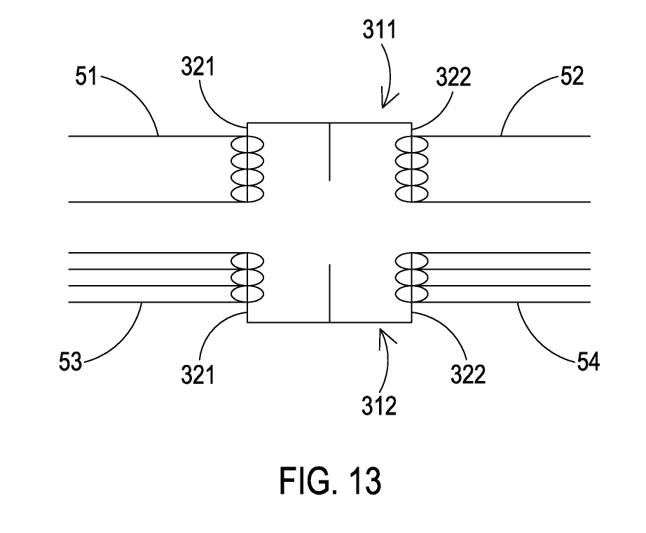

Please refer to FIG. 13. FIG. 13 schematically illustrates the structure of another magnetic assembly according to an embodiment of the present disclosure. As shown in FIG. 13, the first coil 51, the second coil 52, the third coil 53 and the fourth coil 54 are respectively disposed on the first projection 321 of the first magnetic core 311, the second projection 322 of the first magnetic core 311, the first projection 321 of the second magnetic core 312 and the second projection 322 of the second magnetic core 312. The first coil 51 is a primary coil (e.g. a primary winding), the third coil 53 is a secondary coil (e.g. a secondary copper plate), the second coil 52 is another primary coil (e.g. another primary winding), and the fourth coil 54 is another secondary coil (e.g. another secondary copper plate), so that two independent transformers are structured. Take a requirement of a 3000-Volts transformer for example. It can be implemented through single one magnetic assembly of the present disclosure configured with two independent 1500-Volts transformers at the right side and the left side, respectively.

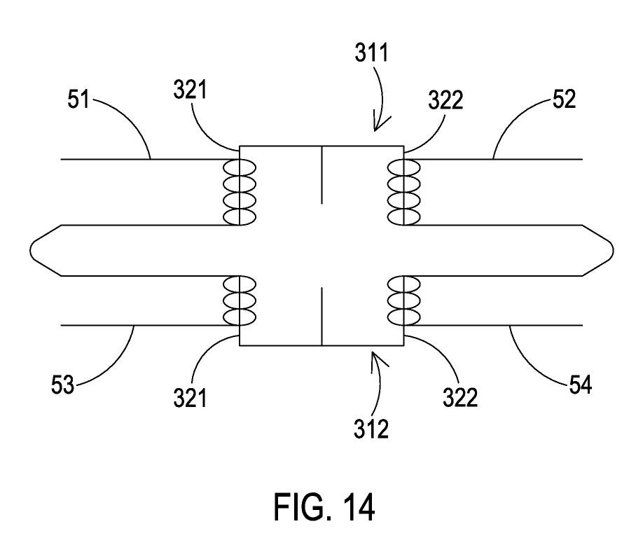

Please refer to FIG. 14. FIG. 14 schematically illustrates the structure of another magnetic assembly according to an embodiment of the present disclosure. As shown in FIG. 14, the first coil 51, the second coil 52, the third coil 53 and the fourth coil 54 are respectively disposed on the first projection 321 of the first magnetic core 311, the second projection 322 of the first magnetic core 311, the first projection 321 of the second magnetic core 312 and the second projection 322 of the second magnetic core 312. The first coil 51, the second coil 52, the third coil 53 and the fourth coil 54 are all windings. The first coil 51 is connected with the third coil 53, and the second coil 52 is connected with the fourth coil 54, so that two independent inductors are structured.

Through the various changes of the embodiments mentioned above, it can be known that the magnetic assembly of the present disclosure can be made with connected coils to fit with the number of watts and the characteristics of the machine, and further can be optimized on disposition. In addition, different coil rows and disposition of copper plates can optimize the transformer characteristics and can be applied to, for example but not limited to, LLC circuits. The offset full bridge LLC circuit is 44:2:2 (small Ae) and 22:1:1 (large Ae). The half bridge LLC circuit is 33:2:2 (small Ae) and 16:1:1 (large Ae). The full bridge LLC circuit is 32:1:1 (small Ae and large Ae are the same, only the B value is halved). In addition, there is no connection solder joint of the coil, so none of a sleeve is needed for protection. Furthermore, the coils and copper plates can be flexibly utilized with different central projection.

On the other hand, when the magnetic assembly of the present disclosure is applied as two transformers, the two transformers are balanced by the self-inductance and mutual inductance, such that the difference of induced voltages becomes smaller. The sudden wave of rectifier is not easy to become larger, so it is not necessary to increase the proportion of the clamp, thereby enhancing the relative efficiency.

From the above description, the present disclosure provides a magnetic assembly, an inductor and a transformer. By the structural features of the length relation between the central projections and the first and second projections of the first magnetic core and the second magnetic core of the magnetic core set, the heat-dissipating directions and the disposed directions between the magnetic assembly and the circuit board of the present disclosure are at least one more than the prior art. Meanwhile, no fixture is needed to fix the magnetic core set in the magnetic assembly of the present disclosure. Only the central projection has to be grinded to control the inductance through the air gap due to the single inductance, so no imbalance phenomena of current and magnetic circuit will be occurred. Therefore, not only the technical issues can be effectively solved without welding and utilizing sleeves, but also the product is thinned, the difficulty of process is lowered, and the magnetic assembly can be flexibly applied.

On the other hand, by respectively disposing the first coil, the second coil, the third coil and the fourth coil on the first projections and the second projections of the first magnetic core and the second magnetic core, and the coil(s) can be wound by single wire, and windings and copper plates can be chosen for meeting actual requirements with the changes of connections in series and connections in parallel, so that the combination of a transformer and an inductor, a transformer with primary side connected in series and secondary side connected in parallel, two independent transformers, and two independent inductor can be implemented. The design is full of diversity. Simultaneously, since the directions of the magnetic fields of the first projection and the second projection are opposite, the magnetic flux can be neutralized and balanced at the central projection, thereby lowering the sudden wave of the rectifier component and then enhancing the efficiency.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic assembly, comprising:
a magnetic core set comprising a first magnetic core and a second magnetic core, wherein the first magnetic core and the second magnetic core are disposed opposite to each other, and the first magnetic core and the second magnetic core each comprises:
a main body having a central portion, a first portion and a second portion, wherein the central portion is located between the first portion and the second portion;
a central projection extending from the central portion;
a first projection extending from the first portion; and
a second projection extending from the second portion,
wherein a length of the first projection and a length of the second projection are equal, and a length of the central projection is greater than the length of the first projection.

2. The magnetic assembly according to claim 1, wherein the main body has a first width edge and a second width edge disposed opposite to each other, and a first length edge and a second length edge disposed opposite to each other, and wherein a width of the central projection corresponding to the first width edge and a width of the central projection corresponding to the second width edge are greater than a width of the central projection corresponding to a center of the main body.

3. The magnetic assembly according to claim 2, wherein the first projection is cylindrical and adjacent to the first length edge, and the second projection is cylindrical and adjacent to the second length edge.

4. The magnetic assembly according to claim 1, wherein the cross-sectional area of the central projection is 1.5 to 2.5 multiple of the cross-sectional area of the first projection.

5. The magnetic assembly according to claim 4, wherein the cross-sectional area of the central projection is twice of the cross-sectional area of the first projection, and the cross-sectional area of the first projection is equal to the cross-sectional area of the second projection.

6. The magnetic assembly according to claim 1, wherein the central projection comprises a first material, wherein the first and second projections comprise a second material, and wherein the first material and the second material have similar magnetic permeability.

7. The magnetic assembly according to claim 1, wherein the central projection comprises a first material, wherein the first and second projections comprise a second material, and wherein the first material has a greater magnetic permeability than the second material.

8. The magnetic assembly according to claim 1, wherein the central projection comprises a first material, wherein the first and second projections comprise a second material, and wherein the second material has a greater magnetic permeability than the first material.

9. The magnetic assembly according to claim 1 further comprising a first coil, a second coil, a third coil and a fourth coil, wherein the first coil, the second coil, the third coil and the fourth coil are respectively disposed on the first projection of the first magnetic core, the second projection of the first magnetic core, the first projection of the second magnetic core and the second projection of the second magnetic core.

10. The magnetic assembly according to claim 9, wherein the first coil is a primary coil, and the third coil is a secondary coil.

11. The magnetic assembly according to claim 10, wherein the second coil and the fourth coil are windings.

12. The magnetic assembly according to claim 10, wherein the second coil is a winding connected with the first coil in series, and the fourth coil is a copper plate connected with the third coil in parallel.

13. The magnetic assembly according to claim 12, wherein the first coil and the second coil are wound by single one wire.

14. The magnetic assembly according to claim 9, wherein the first coil and the second coil are primary coils, and the third coil and the fourth coil are secondary coils.

15. The magnetic assembly according to claim 9, wherein the first coil, the second coil, the third coil and the fourth coil are windings.

16. The magnetic assembly according to claim 1, wherein the height of the first projection of the first magnetic core is equal to the height of the second projection of the first magnetic core, and the height of the first projection of the first magnetic core is greater than the height of the central projection of the first magnetic core.

17. The magnetic assembly according to claim 16, wherein the height of the first projection of the second magnetic core is equal to the height of the second projection of the second magnetic core, and the height of the first projection of the second magnetic core is greater than the height of the central projection of the second magnetic core.

18. The magnetic assembly according to claim 1, wherein the first projection, the second projection and the central projection of the first magnetic core and the first projection, the second projection and the central projection of the second magnetic core have equal height.

19. An inductor, comprising:
a magnetic core set comprising a first magnetic core and a second magnetic core, wherein the first magnetic core and the second magnetic core are disposed opposite to each other, and the first magnetic core and the second magnetic core each comprises:
a main body having a central portion, a first portion and a second portion, wherein the central portion is located between the first portion and the second portion;
a central projection extending from the central portion;
a first projection extending from the first portion; and
a second projection extending from the second portion,
wherein a length of the first projection and a length of the second projection are equal, and a length of the central projection is greater than the length of the first projection;
a first coil disposed on the first projection of the first magnetic core;
a second coil disposed on the second projection of the first magnetic core;
a third coil disposed on the first projection of the second magnetic core and connected with the first coil; and
a fourth coil disposed on the second projection of the second magnetic core and connected with the second coil,
wherein the first coil, the second coil, the third coil and the fourth coil are windings.

20. A transformer, comprising:
a magnetic core set comprising a first magnetic core and a second magnetic core, wherein the first magnetic core and the second magnetic core are disposed opposite to each other, and the first magnetic core and the second magnetic core each comprises:
a main body having a central portion, a first portion and a second portion, wherein the central portion is located between the first portion and the second portion;
a central projection extending from the central portion;
a first projection extending from the first portion; and
a second projection extending from the second portion,
wherein a length of the first projection and a length of the second projection are equal, and a length of the central projection is greater than the length of the first projection;
a first coil disposed on the first projection of the first magnetic core;
a second coil disposed on the second projection of the first magnetic core and connected with the first coil in series;
a third coil disposed on the first projection of the second magnetic core; and
a fourth coil disposed on the second projection of the second magnetic core and connected with the third coil in parallel,
wherein the first coil and the second coil are primary coils, and the third coil and the fourth coil are secondary coils.
